(19) United States
(12) Patent Application Publication
(10) Pub. No.: US 2007/0012530 A1
(43) Pub. Date: Jan. 18, 2007

(54) Bearing damper having dispersed friction damping elements

(76) Inventor: Angel M. Garcia, Jupiter, FL (US)

Correspondence Address: Manny Garcia;Florida Turbine Technologies, Inc., Suite 301, 140 Intracoastal Pointe Drive, Jupiter, FL, 33477, US

(21) Appl. No.: 11/183,135

(22) Filed: Jul. 15, 2005

(51) Int. Cl. F16F 9/30

(52) U.S. Cl. 188/268

(57) ABSTRACT

The present invention is a bearing support apparatus that provides damping to the bearing, and is made of high temperature resistant materials in order that the bearing can be used in a high temperature environment such as a gas turbine engine. The bearing support includes an annular chamber that is filled with a plurality of spherical elements or balls made of a high temperature resistant material like a ceramic, a glass, carbon, or stainless steel. The spherical elements are packed together such that a vibration causes the spherical elements to rub up against each other and dissipate the energy from the vibration. Another embodiment includes a flexible diaphragm within the annular chamber and a pressure fluid source to compact the spherical elements in order to vary the damping capability of the apparatus.

### BACKGROUND OF THE INVENTION

1. Field of the Invention

The present invention relates to a bearing support for use in a high temperature environment in which the bearing support includes a damping capability, and to the same bearing support with a varying damping capability.

2. Description of the Related Art Including Information Disclosed Under 37 CFR 1.97 and 1.98

Prior art bearing supports that include some sort of damping capability are plentiful. Some bearing dampers use a spring-like member, while others use a elastomeric member like a rubber cushion. All of these dampers are not useful under very high temperature environments such as that found in a gas turbine engine, especially near the combustor. A need arises in the art of bearings used in a high temperature environment to provide for a damper that can withstand very high temperatures.

U.S. Pat. No. 6,802,405 B2 issued to Barcock et al. on Oct. 12, 2004 shows a friction vibration damper for damping the vibrations of a vibrating component comprising a body, a chamber and a plurality of elements, the body defines the chamber which is partially filled with the plurality of elements, the friction vibration damper, in use, disposed on or in the vibrating component characterized in that the friction vibration damper is configured to substantially prevent the elements operationally moving in a convection-like flow pattern. The friction vibration damper which is associated with controlling vibrations of a vibrating component and in particular, although not exclusively, a component of a gas turbine engine or a component of a machining operation. The FIG. 18 embodiment of Barcock et al. patent is a section through a friction damper 51 and shows a further embodiment of the present invention comprising the friction damper 51 having a cylindrical body 81 which defines a chamber 82. Disposed within the chamber is a plurality of substantially spherical elements 28 and a number of baffles 76, 78. The cylindrical body 80 comprises a central axis 74, an annular wall 84 surrounding the central axis 74 and end walls 86, 88. The baffles 76, 78, in this embodiment, are attached to the annular wall 84 and extend radially inwardly. It is preferred that the principle direction of greatest amplitude of the vibrating body is parallel to the central axis 74 although this is not essential. The elements 28 interact with one another to provide the damping characteristics of the prior art disclosed herein except that the provision of baffles 76, 78 reduces the convection-like migration flow pattern of the prior art. Therefore the performance of the friction damper 51 is an improvement over the prior art in that once the minimum on the vibration reduction graph (FIG. 4) is achieved it is maintained through any increase in excitation level as the present invention substantially reduces the convection-like movement of elements that would otherwise lead to a loss of vibration reduction ability. The exact configuration this embodiment of the present invention will be determined by the amount of damping required, the size of the elements, the exact percentage fill of elements 28 and the number and radial extent of the baffles 76, 78. Lower aspect ratio friction dampers 51 would require fewer baffles 76, 78.

U.S. Pat. No. 6,547,049 B1 issued to Tomlinson on Apr. 15, 2003 shows a Particle Vibration Damper for a vibrating component comprising a body having a chamber and a plurality of particles, the chamber partially filled with a plurality of particles, the particle vibration damper, in use, disposed to a vibrating component. The object of the Tomlinson invention is to provide a vibration damper for non-rotating engine components and in particular combustor system components of a gas turbine engine. Preferably each chamber is partially filled with particles of substantially the same size. Alternatively each chamber is partially filled with particles of more than one discrete size. Alternatively each of the chambers is partially filled with a plurality of particles of substantially the same size, each plurality of particles in each chamber being of a different discrete size. Preferably the particles are substantially spherical. Preferably the particles are substantially spherical with a diameter of 0.6 millimeters. Alternatively the particles are substantially spherical with a diameter in the range of 0.1 to 5.0 millimeters. Preferably the particles are manufactured from steel but alternatively are metallic. Alternatively the particles are manufactured from ceramic material. Preferably the chamber is filled with particles to between 95 and 100 percent by volume. More specifically, the chamber is filled with particles to 95 percent by volume. Alternatively each of the chambers is filled with particles to 95 percent by volume. Alternatively each of the chambers is filled with particles to a different percentage by volume of each chamber. Alternatively, the chamber is filled with particles to a percentage volume fill such that the particles become fluidized by the vibrations of the vibrating component. Preferably the body of the particle vibration damper is manufactured from steel, but alternatively any metallic substance may be used. Alternatively the body of the particle vibration damper is manufactured from ceramic material. Preferably the body of the particle vibration damper is substantially cylindrical. Preferably, the cylindrical particle vibration damper comprises a D/r ratio of greater than 5. Alternatively the body of the particle vibration damper is substantially parallelepiped. Preferably the body of the particle vibration damper comprises a chamber with a volume of 50000 cubic millimeters. Preferably the vibrating component is an engine component. Preferably, the engine component is any one of the group comprising a transition duct, a combustion chamber. Alternatively, the vibrating component is any one of a work piece, a machine tool, a machine. Preferably, the work piece is subject to a machining operation. Preferably the particle vibration damper is disposed to the vibrating component by temporary means.

Preferably the component, of the gas turbine engine, vibrates in the frequency range 200-1200 Hertz. Preferably the gas turbine engine is an industrial gas turbine engine or alternatively a gas turbine engine for an aircraft or a gas turbine engine for a marine vessel. Preferably a method of damping the vibrations of a vibrating component comprises the steps of, locating the position of the greatest amplitude of vibration on an engine component and disposing a vibration damping device on the component at the position of the greatest amplitude of vibration.

U.S. Pat. No. 3,031,046 issued to Hoadley on Apr. 24, 1959 shows a high temperature structure having internal damping menas, where a plurality of metal spheres that are bonded together are contained within a space such as a turbine blade, the spheres providing an internal damping.

U.S. Pat. No. 3,938,625 issued to Radermacher et al. on Feb. 17, 1976 shows a Vibration Damping Device Especially For Protecting Pipelines From Earthquakes, where the device includes a cylinder, a piston displaceable in the cylinder, and displaceable damping medium including a multiplicity of rollable bodies received in the cylinder.

No. 4,011,929 issued to Jeram et al. on Mar. 15, 1977 shows a Dampening Device Using A Silicone Rubber, the dampening device comprises a closed chamber, a movable piston rod extending through the chamber and an enlarged piston head located on the piston rod. Located in the interior space of the closed chamber under pressure is a compressible solid, fragmented, particulate mass of cured unfilled silicone rubber composition for producing a damping effect on the piston rod and head. The damper device includes a threaded plug for varying the internal static pressure on the compressible mass within the chamber and apertures extending through the piston head or an annular space between the outer edge of the piston head and the interior of the chamber for bypassing the compressible mass.

No. 5,290,973 issued to Kwoh on Mar. 1, 1994 shows a Acoustic Damping Device having a hollow cone partially filled with an acoustic damping medium. The cone is composed of solid material such as wood. The acoustic damping medium can be a particulate solid, such as metal powder, or a liquid. The acoustic damping device is placed between a speaker and a speaker platform to reduce the amount of vibrational interference that reaches the speaker.

U.S. Pat. No. 4,706,788 issued to Inman et al. on Nov. 17, 1987 shows a Vibration Damped Apparatus that comprises a damping mass which is mechanically coupled to damp the oscillations of a member. The damping mass is comprised of a plurality of sub-masses which are distributed in a material, preferably an elastic material, such that at least a majority of the sub-masses in the elastic material are spaced from the axis of oscillatory movement. The sub-masses are preferably spaced in close proximity to each other so that at least a substantial portion of the masses spatially interfere with each other during the oscillation of the member. The damping mass is formed of a mixture of sub-masses and elastic material, such that the sub-masses are substantially uniformly distributed through the elastic material. The sub-masses are each coated with the elastic material but are distributed in close proximity such that the sub-masses are closer to each other than the diameter of the sub-masses to cause the sub-masses to be substantially touching each other during oscillation of the vibrating member. By way of example, the sub-masses may be spherical and formed of lead. The elastic material preferably comprises a viscoelastic material having a shear modulus which varies nonlinearly throughout a range of frequencies.

U.S. Pat. No. 6,418,862, issued to Heil on Jul. 16, 2002 shows a Shock Absorbing Pallet in which the pallet comprises a base and a plurality of support members attached to the base. Each support member comprises an upper housing, a lower housing and shock absorbing material located within the two housings. When a force or vibration is exerted on the pallet the upper housing and lower housing move to a compressed configuration thereby reducing the amount of shock transferred to the upper face of the pallet. When the force on the pallet is removed, the upper housing and lower housing return to an expanded configuration.

U.S. Pat. No. 6,116,784, issued to Brotz on Sep. 12, 2000 shows a Dampenable Bearing, in which the object of this invention to provide an improved dampening mechanism between an object such as a work piece and its base support. In order to create the desired object movement dampener, the invention herein provides for an object mounting plate disposed above a base and separated there from by a plurality of bearings there between. Ball bearings are illustrated, but other types of bearings could be substituted therefore such as roller bearings. Other types of bearings are to be considered within the scope of this invention and whenever ball bearings are described, it should be understood that other types of bearings could be utilized in their place. Initially the mounting plate on which the object or work piece is attached can freely move around in position on top of the ball bearings rolling on the base. Beneath the mounting plate is an upper electrode plate and above the base is a lower electrode plate with a flexible retaining member such as an elastic ring connecting the upper electrode plate and lower electrode plate. An electro or magneto theological fluid is disposed between the upper electrode plate and lower electrode plate and fills the spaces between the ball bearings. In one embodiment an electric current is conducted between the upper electrode and lower electrode plates, when desired, which thickens and then solidifies the electro rheological fluid, depending on the current intensity. If a magneto rheological fluid is used, a magnetic field can be applied to such magneto rheological fluid to stiffen it which process also limits the ability of the ball bearings to move and dampens the ability of the object or work piece attached to the mounting plate to move in relation to the base. Electro or magneto rheological fluid having similar properties to ferro fluids which are magnetic can help make good seals between the bearings' fluid-containing members forming the bearing confinement chamber so as to help prevent fluid leakage. The confinement chamber can also be embodied in other shapes from that shown, such as bellows-shaped, which shape can also accomplish the goals of this invention.

Neither the above sited Prior Art disclosures is for a bearing damper that can be used in a high temperature environment such as near a combustor in a gas turbine engine.

It is therefore an object of the present invention to provide for a bearing support that provides a damping capability for the bearings.

It is another object of the present invention to provide for a bearing support damper that can operate under very high temperatures such as a temperature around a combustor in a gas turbine engine.

It is still another object of the present invention to provide for a bearing support damper that can vary the damping characteristic.

### BRIEF SUMMARY OF THE INVENTION

The present invention accomplishes the above objectives by providing for a bearing support to comprise an annular chamber wrapped around the bearing outer race, in which the annular chamber is filled with a plurality of spherical elements that are made of a high temperature resistive material such as a ceramic, and that the spherical elements include a surface that would best convert rubbing movement between elements into friction to produce the damping affect desired.

A further embodiment of the present invention includes a flexible diaphragm member in contact with the spherical elements that also forms a pressure chamber within the annular chamber, and a pressure source to regulate the pressure acting against the diaphragm in order to control a compactness of the spherical elements to vary the damping capacity of the bearing support.

### BRIEF DESCRIPTION OF THE SEVERAL VIEWS OF THE DRAWINGS

FIG. 1 shows a cross section view of a roller bearing with a bearing support member filled with tiny spherical elements.

FIG. 2 shows a cross section view of a second embodiment of the bearing support of FIG. 1, in which a flexible bellows forms a pressurized chamber to vary the compactness of the spherical elements to vary damping.

### DETAILED DESCRIPTION OF THE INVENTION

The present invention is a bearing support member for a rolling element bearing, the support member having a flexible compartment that is filled with small spherical elements that rub up against each other to disperse energy from vibration of the bearing, thus dampening the bearing. A rolling element bearing includes an inner race 26, and outer race 22, and a plurality of roller elements 24 positioned between the two races. A bearing support member includes a thick walled portion 12, a support plate 16 in contact with a casing or rigid structure 20 in which the bearing and support is mounted, and a thin wall portion 18. The casing or rigid support structure 20 is defined in this disclosure to be a surface on which the bearing and the support bearing is mounted. Tiny ball elements 14 fill the annular cavity 28 that is formed between wall portions 12, 16 and 18.

The wall portions 12, 16, and 18 are made of a high temperature resistant material that can flex somewhat in the radial direction of the bearing. The wall portion material can be high temperature stainless steel, a ceramic matrix composite material, or even a carbon fiber laminated material in which the fibers are oriented to provide a rigid support in all but the above mentioned radial direction to allow a little flexibility in the radial direction but remain rigid in all other directions for bearing support.

The wall portions 18 can be made of any high temperature resistant material such as ceramics, glass, carbon, or stainless steel. The purpose of the spherical elements 14 is to rub up against each other and disperse energy by rubbing. As the bearing shaft/system moves in the radial direction, the flexible wall portions will flex in the radial direction. Since the casing member 20 is relatively rigid and does not move, and the outer wall portion 16 rests up against the casing wall portion 18, the only members that will move or vibrate with the bearing is the side wall portions 12 and the inner thin wall portion 18. When the side wall portions 12 and the inner wall portion 18 flexes, the ball elements 14 are moved around to cause the ball elements 14 to rub up against each other. This rubbing produces friction that will dissipate the energy induced by the radial motion, and acts to dampen the shaft dynamic loads.

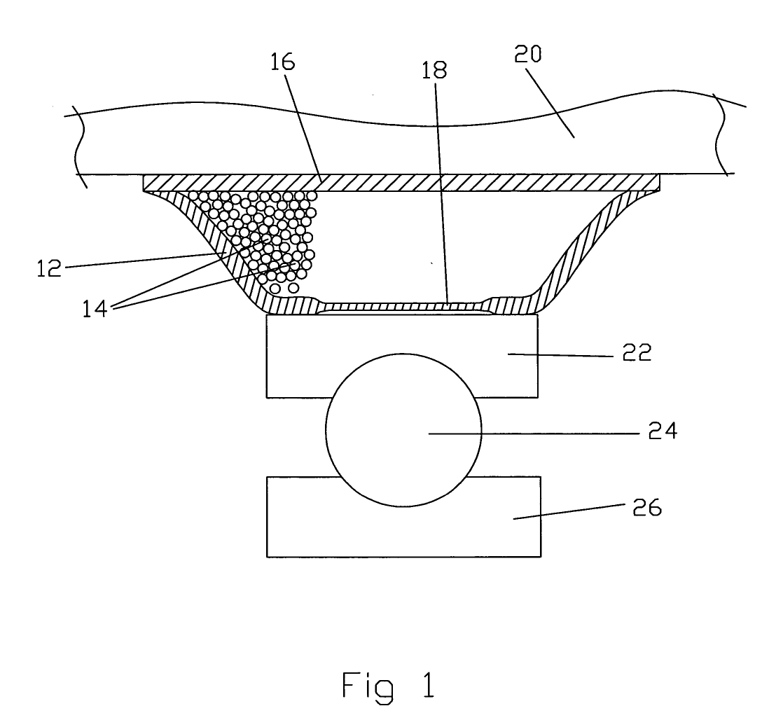

The bearing used in this present invention of FIG. 1 is shown as a ball bearing. However, a roller bearing could also be used, as could any other well known bearing that has the structure to be secured within the inner wall portion 18 of the bearing support structure. Because the bearing support is made from materials that can withstand very high temperatures, the support can be used for a bearing used in a high temperature environment, such as a bearing in a gas turbine engine near the combustor section.

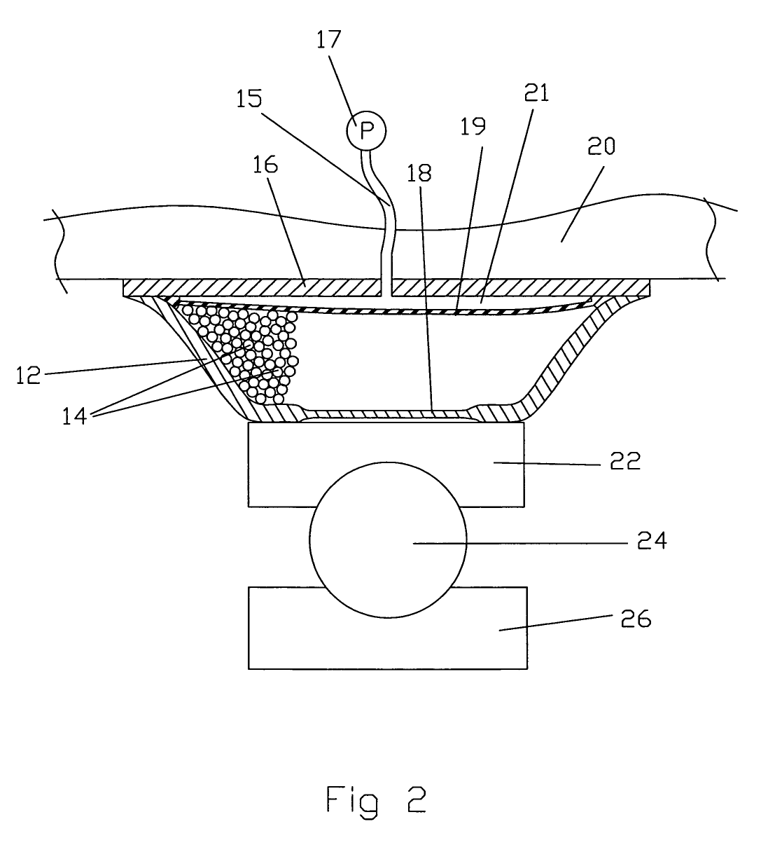

The size and compaction (density) of the spherical elements will determine the degree of damping that can be achieved. In addition, an active scheme for varying the compactness of the spherical elements can be employed to vary the degree of damping as shown in the FIG. 2 embodiment. The bearing support of FIG. 1 includes a flexible diaphragm 19 having ends secured to the inside of the wall portions 12 and 16. The flexible diaphragm can be made of any high temperature resistant material such as stainless steel, but must be thin enough to provide the flexibility in order to compact the spherical elements under a pressure acting in the chamber 21. The diaphragm forms a chamber 21 between the wall portion 16 and the diaphragm 19, and a tube 15 connects a pressure source 17 to the chamber 21 through a hose 15. The compactness of the spherical elements 14 can be increased by applying a pressure to the chamber 21. As the compactness of the spherical elements 14 increases, the damping affect can be increased. Varying the dampness can be useful in a system in which less damping is needed during a startup process, while more damping is needed at a steady state rotation of the bearing. Other situations exist in which it would be desirable to vary the damping of the bearing.

1. A bearing support apparatus, comprising:
An annular chamber having an inner wall surface and an outer wall surface, the outer wall surface forming a means to support the bearing support, and the inner wall surface forming a means to support a bearing outer race, the annular chamber forming a substantially closed chamber; and,
A plurality of spherical elements disposed within the annular chamber, the spherical elements occupying substantially the entire volume of the annular chamber.

2. The bearing support apparatus of claim 1, and further comprising:
The spherical elements and the annular chamber being formed of a high temperature resistant material.

3. The bearing support apparatus of claim 1, and further comprising:
The inner wall surface of the annular chamber has a thickness less than the thickness of the outer wall surface in order to provide flexibility to the annular chamber.

4. The bearing support apparatus of claim 1, and further comprising:
The annular chamber is formed from stainless steel.

5. The bearing support apparatus of claim 1, and further comprising:
The outer wall surface has a width in a cross section view greater than the width of the inner wall surface.

6. The bearing support apparatus of claim 1, and further comprising:
A flexible diaphragm secured within the annular chamber and forming a pressure chamber on one side of the annular chamber and a spherical element chamber on the other side of the annular chamber; and,
A fluid pressure supply means to supply a fluid pressure to the pressure chamber to compact the spherical elements.

7. The bearing support apparatus of claim 6, and further comprising:
The flexible diaphragm being formed of a high temperature resistant material.

8. The bearing support apparatus of claim 7, and further comprising:
The flexible diaphragm being formed of stainless steel.

9. The bearing support apparatus of claim 1, and further comprising:
The spherical elements are formed from one or more of a ceramic material, a glass material, a carbon material, and a stainless steel material.

10. A process for damping vibration from a bearing, the process comprising the steps of:
Providing for an annular chamber having a bearing support surface one side and a rigid support surface on another side of the annular chamber; and,
Filling the annular chamber with a plurality of spherical elements such that a vibration from the bearing will produce friction against some of the plurality of spherical elements to dissipate the vibrations.

11. The process for damping vibration from a bearing of claim 10, and further comprising the step of:
Providing for the annular chamber and the spherical elements to be made of a high temperature resistant material.

12. The process for damping vibration from a bearing of claim 10, and further comprising the step of:
Providing for a flexible diaphragm within the annular chamber, the flexible diaphragm forming a pressure chamber and a spherical element chamber; and,
Providing for a pressure fluid supply means to supply a pressure fluid to the pressure chamber to compact the spherical elements.

13. The process for damping vibration from a bearing of claim 10, and further comprising the step of:
Providing for the bearing support surface to have a width less than the width of the rigid support surface.

14. The process for damping vibration from a bearing of claim 10, and further comprising the step of:
Providing for the spherical elements to be made from one or more of a ceramic material, a glass material, a carbon material, and a stainless steel material.
